(19) United States
(12) Patent Application Publication
(10) Pub. No.: US 2005/0132688 A1
(43) Pub. Date: Jun. 23, 2005

(54) Header having an angled transverse feeding channel

(75) Inventor: Alfons Resing, Stadtlohn (DE)

Correspondence Address: Jimmie R. Oaks;Patent Department, DEERE & COMPANY, One John Deere Place, Moline, IL, 61265-8098, US

(73) Assignee: Maschinenfabrik Kemper GmbH & Company KG

(21) Appl. No.: 10/989,813

(22) Filed: Nov. 16, 2004

(30) Foreign Application Priority Data
Dec. 17, 2003 (DE) 103 59 091.9

(51) Int. Cl. A01D 45/02

(52) U.S. Cl. 56/51

(57) ABSTRACT

A header for mowing stalk crops is equipped with several mowing and feed devices which are disposed on both sides of the longitudinal mid-plane of the header. Along the backs of the mowing and feed devices at each side of the header there is a transverse conveyor channel through which plants, harvested by the mowing and feed devices, are conveyed to the center of the header. At the center of the header deflecting conveying elements are disposed on both sides in front of a feed channel of a forage harvester and operate to deflect the plants to the rear so as to transfer them to the feed channel. The transverse conveying channels are disposed at an angle relative to the transverse direction. Preferably, an extension of an imaginary line lying along the transverse conveying channel at each side of the header intersects the opposite deflecting conveying elements at or behind a point where the deflecting conveying elements move to a greater extent rearward than toward the longitudinal mid-plane of the header.

### FIELD OF THE INVENTION

The invention relates to a header for mowing stalk crops with several mowing and feed devices which are disposed on both sides of the longitudinal mid-plane and at the backs of which there is a transverse conveyor channel, through which the plants, harvested by the mowing and feed devices, are conveyed to the center of the header, in which they are deflected rearward by means of deflecting conveying elements, disposed on both sides ahead of a feed channel of a forage harvester, and transferred to the feed channel.

### BACKGROUND OF THE INVENTION

Headers of the aforesaid type are used in agriculture to cut stalk crops, for example, corn plants, from the soil of a field and to convey them to a harvester carrying the header. The harvester includes a chopper drum for chopping the plants into pieces which are discharged into a loading container on a trailer. Headers of this type usually have several mowing and feed devices, arranged laterally adjacent to one another and operating independently of rows, in the form of drums rotating around respective vertical axes. Each of the drums is provided with notches distributed around its periphery, in which the plant stalks are taken up, as well as with mowing disks arranged below the drums, which are used to cut the plant stalks from the soil.

In a customary design of headers of this type, a cross-feed screw of the header is mounted upstream of the feed channel of the forage harvester. The mowing and feed devices take the crop at their backs to the cross-feed screw, which conveys it to the center of the header and there transfers it to the feed channel. Headers of this type are disclosed, for example, in DE 38 28 293 C, DE 195 23 255 A, DE 199 53 521 A, DE 101 03 595 C, DE 101 51 849 C, and EP 1 305 995 A. It is disadvantageous that the cross-feed screw increases the overall length, weight, and torque of the header on the forage harvester.

In other headers for mowing stalk crops, the cross feed of the crop occurs by means of other inwardly disposed mowing and feed devices. It can occur on the front side thereof (EP 0 099 527 A) or the back (DE 40 02 344 A, DE 195 27 607 A, EP 1 334 651 A, DE 102 49 457 A), whereby the transverse conveyor drums, supporting the conveying, or driven clearers or strippers are used. The conveying on the front of the mowing and feed devices has not become accepted in practice. In headers with conveying at the backs of the mowing and feed devices, usually in the center of the header on both sides of the feed channel, so-called slope conveyor drums are disposed, which rotate around approximately vertical but slightly forward inclined axes. They deflect the plant stream rearward from the transverse conveying channel and overcome the height difference between the plane of the header and the plane of the feed channel.

In headers of this type, sometimes the deflection of the plants in the feed channel of the forage harvester proves to be problematic, particularly at rather high working widths, at which the plant stalks entering the outer area of the header are transported over relatively long distances. In uneven stands, they can come into an inclined position, which is caused in part by the heavy, high-hanging corn cobs, because they cannot then be supported by the other plants. The plant stalks bounce out of the transport path and without guidance pass by the central feed channel to the forage harvester and block the entire feed area.

The problem underlying the invention was to provide a header for mowing stalk crops in which the above-stated problems do not occur or occur to a reduced extent.

### SUMMARY OF THE INVENTION

According to the present invention, there is provided an improved header for harvesting stalk crops.

An object of the invention is to provide a header including a plurality of mowing and feed devices located on each side of a mid-plane of the header so as to convey harvested plants to a transverse conveyor channel at the opposite sides of a longitudinal mid-plane of the header so as to form a V which opens in a forward direction of travel of the header.

The plants are transported through the transverse conveyor channels, which are located behind the mowing and feed devices, to the center of the header. There they are deflected rearward by means of the deflecting conveying elements and transferred to the feed channel of a forage harvester carrying the header. One of the deflecting conveying elements is located in front of the feed channel on each side of the feed channel. It is proposed to dispose the transverse conveying channels in the form of a “V” open in front in the forward direction, so that the plants in the transverse conveying channel also achieve a rearward directed velocity component opposite to the forward direction; the result is that they can be deflected more easily rearward by the deflecting conveying elements into the feed channel.

Preferably an imaginary extension of the transverse conveying channel intersects the deflecting conveying elements at a place where the deflecting conveying elements move more rearward than to the center of the header, in the case of a rotating deflecting conveying element therefore at an angle of at most 45° relative to the transverse direction, or behind said place. It is also conceivable that the imaginary extension of the transverse conveying channel runs behind the axis of rotation of the deflecting conveying elements. This condition means that the plants enter at an angle of less than 90° to the normal of the deflecting conveying elements; i.e., they are conveyed by the deflecting conveying elements not opposite their original direction of motion, but rearward only still orthogonal thereto.

It is achieved in this manner that plant stalks perhaps escaping from the transverse conveying channel encounter a place on the deflecting conveying elements on the opposite side, where they can be conveyed non-problematically rearward into the feed channel. Thereby, blockage of the crops can be prevented in a simple and effective manner.

It is not absolutely necessary, but possible, that the transverse conveying channel extend over its entire length at an angle to the transverse direction. It is sufficient if only the area of the transverse conveying channel next to the longitudinal mid-plane forms an angle with the transverse direction. This area should be at least as long as the plants to be harvested, however.

The conveying of the plants can occur by means of the backs of the mowing and feed devices and/or by separate conveyors.

It is furthermore conceivable to provide the header with a movable frame, so that it becomes possible to move the mowing and feed devices in such a way that the transverse conveying channel can be moved between a first position, in which it runs transverse to the forward direction, and a second position, in which it is oriented at an angle to the transverse position. The first position can be chosen with non-problematic stands, whereas the second position is used in non-uniform stands.

### BRIEF DESCRIPTION OF THE DRAWINGS

Four exemplary embodiments of the invention, described in greater detail below, are shown in the drawings.

FIG. 1 is a schematic top view of a first embodiment of a header of the invention for mowing stalk crops.

FIG. 2 is a schematic top view of a second embodiment of a header of the invention,.

FIG. 3 is a schematic top view of a third embodiment of a header of the invention.

FIG. 4 is a schematic top view of a fourth embodiment of a header of the invention.

### DESCRIPTION OF THE PREFERRED EMBODIMENT

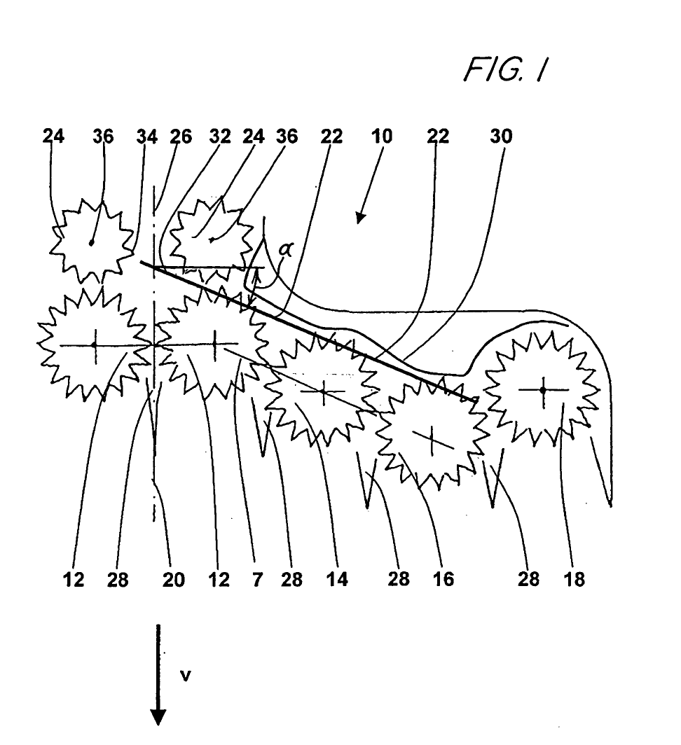

FIG. 1 shows a schematic top view of half of a first embodiment of a header 10 of the invention for mowing stalk crops, for example, corn. It comprises several mowing and feed devices 12, 14, 16, 18, which are equipped in a manner known per se with cutting disks rotating around a vertical axis and conveyor disks disposed above these, with notches distributed around their periphery to take up the stems of the cut plants. Mowing and feed devices 12-18 of this type are disclosed in detail in EP 0 099 527 A, the content of which is incorporated into the present documents by reference.

In FIG. 1, to simplify the description, only the half of the header 10 on the left side of the longitudinal mid-plane 20 of the header 10, relative to the forward direction V in which the header 10 moves over a field for harvesting, and the inner part of the right half are shown completely. The right half, however, in reality is a mirror image to the left half. The header 10 accordingly has eight mowing and feed devices 12-18, with which eight rows of plants sown at a distance of 75 cm can also be harvested simultaneously.

The mowing and feed devices 18 disposed furthest outward rotate such that the cut plants are conveyed inwardly, at the front of the mowing and feed devices 18, in the direction of the longitudinal mid-plane 20 of the header 10. At the point next to the longitudinal mid-plane 20 or shortly upstream therefrom, the plants are lifted out of the conveying disks of the mowing and feed device 18 by means of clearers or strippers (not shown) and transferred to the back of the next inner mowing and feed device 16, which turns in a direction opposite to the outer mowing and feed device 18.

Next, the plants at the back of the mowing and feed device 16 are lifted out of the conveyer disks thereof by means of a clearer and conveyed further by means of a transverse conveying drum (not drawn) rotating about a vertical axis, the lifters of which penetrate a back wall 30 at the back of the transverse conveying channel 22, and transfer to the back of the next inner mowing and feed device 14.

Then, the plants are removed by means of another clearer from the conveying disks of the mowing and feed device 14 and, supported by means of another transverse conveying drum, are transferred to the back of the inner mowing and feed device 12.

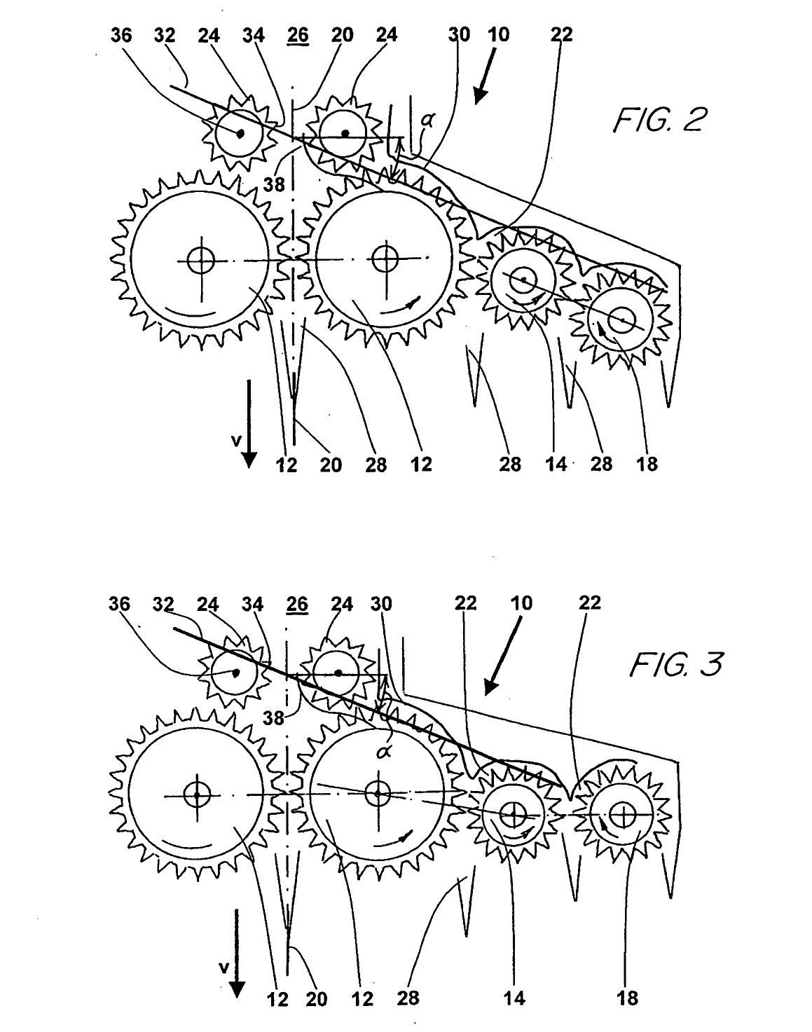

The inner mowing and feed device 12 then transfers the plants, supported by means of clearers 38 (see FIG. 2), to the deflecting conveying elements 24 in the form of a sloping conveying drum. The deflecting conveying elements 24 rotate around an approximately vertical, but slightly forward inclined axis, to overcome the height difference between the plane of the header 10 and a feed channel 26 of a subsequent forage harvester. The deflecting conveying elements 24 are disposed in each case on a side of feed channel 26 at opposite sides of an intersection of imaginary lines 32 that diverge in a forward direction so as to define a V. Stalk dividers 28 are disposed in each case between adjacent mowing and feed devices 12-18.

The described construction of the header corresponds approximately to that known from EP 0 760 200 A. On the back of the mowing and feed devices 12-18, the defined transverse conveying channel 22 is located between the mowing and feed devices 12-18 and the back wall 30. Plants cut by the by the mowing and feed devices 12-18 enter into the conveying channel 22 and are transported to the center of the header 10. The plants are deflected rearward at the center of the header 10 by the deflecting conveying elements 24 located at the back or outside of the transverse conveying channel 22 and fed into the feed channel 26.

As taught by the invention, the transverse conveying channel 22, however, is disposed at a preceding angle relative to the transverse direction, i.e., the horizontal direction running perpendicular to the longitudinal mid-plane 20. The transverse conveying channels 22 on both sides of the longitudinal mid-plane 20 form a wide open “V.” The mowing and feed devices 12-16 are disposed successively far in front in the forwardly opening V to achieve the depicted course of the transverse conveying channel 22. Only the outer mowing and feed devices 18 are disposed far behind relative to the next inner mowing and feed device 16, which is made possible by their rotation direction.

As stated above, the imaginary line 32 is located centrally along the transverse conveying channel 22. This imaginary line 32 intersects the deflecting conveying elements 24 of the other half of the header 10 at a point 34, where the deflecting conveying elements 24 move more rearward than toward the longitudinal mid-plane 20. Specifically, the point 34 is displaced forward by an angle α of approximately 15° relative to the point, next to the longitudinal mid-plane 20, of the deflecting conveying elements 24. The extension 32 also runs behind the axis of rotation 36 of the deflecting conveying elements 24. The advantage of the angle α and the spatial arrangement of the extension 32 and the point 34 is that plants, which for any reason have escaped from the transverse conveying channel 22, reach the deflecting conveying elements 24 on the other side of the header 10 at a point 34, where they can be easily conveyed rearward into the feed channel 26. As a result, blockage of the crops can be easily avoided.

FIG. 2 shows a second embodiment of a header 10 of the invention. Elements coinciding with the first embodiment are labeled with the same reference numbers. In this header 10, the inner mowing and feed devices 12 have a greater diameter (about 1.5 m for taking in two plant rows sown at a distance of 75 cm) than the outer mowing and feed devices (about 75 cm) 14, 18. The transverse conveying channel also extends at an angle α to the transverse direction, and its extension 32 intersects the opposite deflecting conveying elements 24 an their inner side. Through the use of the relatively large inner mowing and feed devices 12 the angle α can be achieved without major lengthening of the header 10 in forward direction V.

In the third embodiment shown in FIG. 3, the sole difference relative to the second embodiment is that the outer mowing and feed device 18 is not displaced forward relative to the next inner mowing and feed device 14. The overall length of the header 10 in the forward direction V can be reduced somewhat as a result, without the form and direction of the transverse conveying channel 22 being disadvantageously affected. It is also evident from FIG. 3 that it is sufficient, if only one part, adjacent to the longitudinal mid-plane 20, of the transverse conveying channel 22 runs in a direction oriented at the angle α to the transverse direction, as long as its length corresponds to the length of a plant stalk. In FIG. 3, the outer areas of the transverse conveying channel 22 are arranged in the area between the mowing and feed devices 14 and 18, namely, transverse to forward direction V.

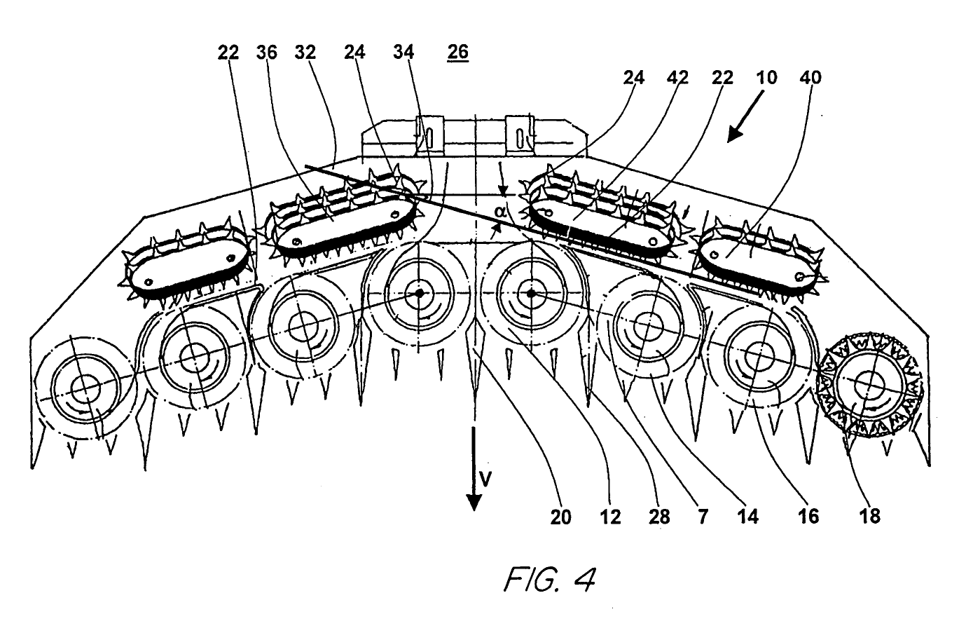

The embodiment shown in FIG. 4 corresponds approximately to the one shown in FIG. 1 with the difference that the plants in the transverse conveying channel 22 are conveyed at the back of the mowing and feed devices 12-18 through separate conveyors 40, 42 and independent of the mowing and feed devices 12-18. The conveyors 40, 42 are belt conveyors, which run around driven rolls mounted for rotation about respective approximately vertical axes. The inner conveyors 42 form simultaneously the deflecting conveying elements 24 at their ends adjacent to the longitudinal mid-plane 20. A header with conveyors of this type, or, alternatively, with other embodiments of the conveyors, for example, with rotating drums, is disclosed in DE 19856444 A, the content of which is incorporated into the present documents by reference. Here as well, the transverse conveyor channels 22 are disposed at a preceding angle α to the transverse direction, and the imaginary line 32 intersects the deflecting conveying elements 24 of the opposite half of the header 10 at the inner side of the deflecting conveying elements 24, at which these move more rearward than to the center of the header 10 and an extension of the imaginary line 32 is behind the axes of rotation of the deflecting conveying elements 24. Because of the rearward directed velocity component, the plants can be deflected more easily by means of the deflecting conveying elements rearward into the feed channel 26. Plants perhaps escaping from the transverse conveying channel 22 are caught by the deflecting conveying elements 24 and conveyed rearward into the feed channel 26.

Having described the preferred embodiment, it will become apparent that various modifications can be made without departing from the scope of the invention as defined in the accompanying claims.

1. In a header for mowing stalk crops including a plurality of mowing and feed devices disposed on both sides of a longitudinal mid-plane of the header, a transverse conveyor channel being defined at back sides of said plurality of mowing and feed devices through which the plants harvested by said mowing and feed devices are conveyed to a center region of said header adapted for being aligned with a longitudinally extending feed channel of a forage harvester, and deflecting conveying elements located on opposite sides of said center region for deflecting said plants in a rearward direction, the improvement comprising: said transverse conveying channels being angled outwardly and forwardly at an angle α relative to said mid-plane.

2. The header, as defined in claim 1, wherein said transverse conveying channel at each side of said mid-plane of the header lies along an imaginary line having an extension which is so located relative to deflecting conveying elements on an opposite side of said mid-plane from said transverse conveying channel that plants which travel along said extension are deflected to the rear by said deflecting conveying elements on said opposite side of said mid-plane.

3. The header, as defined in claim 3, wherein said deflecting conveying elements on said opposite side of said mid-plane from said transverse conveying channel is mounted for rotation about an upright axis of rotation; and said extension of said imaginary line passing behind said upright axis of rotation.

4. The header, as defined in claim 1, wherein each of said deflecting conveying elements are mounted for rotating about an approximately vertical, but slightly forward inclined axis, to overcome a height difference between said header and said feed channel.

5. The header, as defined in claim 1, wherein said transverse conveying channels on both sides of the longitudinal mid-plane each include only an inner section oriented at an angle α to said mid-plane, with this inner section having a length greater than a length of a plant to be harvested.

6. The header, as defined in claim 1, wherein all of said mowing and feed devices, with the exception of the farthest outwardly disposed mowing and feed devices, convey the harvested crop with their backs through the transverse conveying channel.

7. The header, as defined in claim 1, wherein at least a pair of separate conveyors are provided at a rear side of each transverse conveying channel for aiding in moving harvested plants toward said center region of said header.
